(19) United States
(12) Patent Application Publication
(10) Pub. No.: US 2022/0350063 A1
(43) Pub. Date: Nov. 3, 2022

(54) HIGH SURFACE QUALITY OPTICAL FILM

(71) Applicant: META PLATFORMS TECHNOLOGIES, LLC, Menlo Park, CA (US)

(72) Inventors: Andrew John Ouderkirk, Kirkland, WA (US); Sheng Ye, Redmond, WA (US); Christopher Yuan Ting Liao, Seattle, WA (US); Arman Boromand, Issaquah, WA (US)

(21) Appl. No.: 17/401,481

(22) Filed: Aug. 13, 2021

Related U.S. Application Data
(60) Provisional application No. 63/181,361, filed on Apr. 29, 2021.

(51) Int. Cl. G02B 5/30

(52) U.S. Cl. CPC G02B 5/305; G02B 5/3058; G02B 1/041

(57) ABSTRACT

A thin film assembly includes an optical thin film and a discontinuous spacer layer disposed over a major surface of the optical thin film. Within a multilayer stack of optical thin films, the spacer layer may be located between opposing regions of adjacent thin films such that the spacer layer separates the adjacent thin films and inhibits or prevents surface-to-surface contact.

### CROSS-REFERENCE TO RELATED APPLICATION

This application claims the benefit of priority under 35 U.S.C. § 119(e) of U.S. Provisional Application No. 63/181,361, filed Apr. 29, 2021, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic view of a single-stage thin film orientation system for manufacturing an optically anisotropic polymer thin film according to some embodiments.

FIG. 2 illustrates a process for integrating a discontinuous spacer layer with a high surface quality optical film according to some embodiments.

FIG. 3 is an illustration of a pair of stacked high surface quality optical films integrated with a spacer layer according to some embodiments.

FIG. 4 is an illustration of a high surface quality optical film having a discontinuous spacer layer disposed over both major surfaces thereof according to certain embodiments.

FIG. 5 is an illustration of example high surface quality optical films integrated with a discontinuous spacer layer and formed into rolls according to some embodiments.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Polymer and glass thin films may be incorporated into a variety of optical systems and devices, including birefringent gratings, reflective polarizers, optical compensators and optical retarders for systems using polarized light such as liquid crystal displays (LCDs). Birefringent gratings may be used as optical combiners in augmented reality displays, for example, and as input and output couplers for waveguides and fiber optic systems. Reflective polarizers may be used in many display-related applications, particularly in pancake optical systems and for brightness enhancement within display systems that use polarized light. For orthogonally polarized light, pancake lenses may use reflective polarizers with extremely high contrast ratios for transmitted light, reflected light, or both transmitted and reflected light.

Various optical properties of polymer and glass thin films, including refractive index, optical dispersion, birefringence, photosensitivity, photochromism, and the like, may be leveraged for these and other applications. Also potentially relevant are the surface characteristics of polymer and glass thin films, which may impact the reflection, transmission, and absorption of light. For certain applications, one or both major surfaces of a polymer or glass thin film may be advantageously smooth (e.g., scratch-free), smudge-free, and defect-free. For instance, example high surface quality polymer and glass thin films may have a surface roughness (Rₐ) of less than approximately 10 micrometers over an area of at least approximately 1 cm².

Optical thin films may be protected through the application of a temporary liner. Particularly upon its removal, however, a continuous liner may create distortion of the film's surface, including the formation of unwanted orange peel effects. Notwithstanding recent developments, it would be advantageous to provide mechanically robust, high surface quality thin films that may be incorporated into various optical systems including display systems for artificial reality applications.

The instant disclosure is thus directed generally to high surface quality thin films and their methods of manufacture, and more specifically to methods and structures where nascent thin films may be stacked or rolled pending further processing, wherein the as-formed optical quality surfaces of such thin films may be protected by incorporating a stand-off layer into the stacked or rolled architectures. In accordance with various embodiments, a discontinuous spacer layer may be integrated into thin film manufacturing for producing polymer and glass thin films having high optical quality and low surface defects. The discontinuous spacer layer may protect the surface of an optical film from abrasion, debris, and the like, i.e., during manufacture, packaging, storage, etc.

A thin film assembly may include a high surface quality optical thin film and a discontinuous spacer layer disposed over (e.g., directly over) a major surface of the optical thin film. The optical thin film may include a glass or a polymer composition, for example, and may be characterized by a thickness of less than approximately 100 micrometers. Example glasses may include silica, soda lime glass, borosilicates, and silica-titania compositions, although further glass compositions are contemplated. Example polymers may include poly(methyl methacrylate), polycarbonate, polyethylene terephthalate, polyethylene naphthalate, cyclic olefin polymers, and cyclic olefin copolymers, as well as combinations thereof.

In some embodiments, at least one surface of a high surface quality optical film may have a surface roughness (Rₐ) of less than approximately 1000 nm, e.g., less than approximately 500 nm, less than approximately 200 nm, less than approximately 100 nm, less than approximately 50 nm, less than approximately 20 nm, less than approximately 10 nm, less than approximately 5 nm, or less than approximately 2 nm, including ranges between any of the foregoing values. Various embodiments relate to the manufacture of such high surface quality thin films.

As used herein, an “optical quality thin film” or an “optical film” and the like may, in some examples, be characterized by a transmissivity within the visible light spectrum of at least approximately 20%, e.g., 20, 30, 40, 50, 60, 70, 80, 90 or 95%, including ranges between any of the foregoing values, and less than approximately 10% bulk haze, e.g., 0, 1, 2, 4, 6, or 8% bulk haze, including ranges between any of the foregoing values. In particular examples, optical films may exhibit a transmissivity of at least approximately 20% and bulk haze of less than approximately 10% over the entire visible light spectrum (e.g., from approximately 380 nm to approximately 750 nm).

In some embodiments, polymer thin films may be un-oriented or oriented. In particular embodiments, an oriented polymer thin film may be optically anisotropic. The presently disclosed polymer and glass thin films may be characterized as optical quality thin films and may, as single layers or multilayer stacks, form or be incorporated into an optical element such as a birefringent grating, optical retarder, optical compensator, reflective polarizer, etc. Such optical elements may be used in various display devices, such as virtual reality (VR) and augmented reality (AR) glasses and headsets.

In particular embodiments, and by way of example, a reflective polarizer may include a multilayer architecture of alternating (i.e., primary and secondary) layers. In certain aspects, the primary and secondary layers may be respectively configured to have (a) refractive indices along a first in-plane direction (e.g., along the x-axis) that differ sufficiently to substantially reflect light of a first polarization state, and (b) refractive indices along a second in-plane direction (e.g., along the y-axis) orthogonal to the first in-plane direction that are matched sufficiently to substantially transmit light of a second polarization state. That is, a reflective polarizer may reflect light of a first polarization state and transmit light of a second polarization state orthogonal to the first polarization state.

As used herein, “orthogonal” states may, in some examples, refer to complementary states that may or may not be related by a 90° geometry. For instance, “orthogonal” directions used to describe the length, width, and thickness dimensions of a thin film may or may not be precisely orthogonal as a result of non-uniformities in the thin film. In a multilayer structure, one or more of the layers, i.e., one or more primary layers and/or one or more secondary layers, may be characterized by a directionally-dependent refractive index. One or more of the layers, i.e., one or more primary layers and/or one or more secondary layers, may be characterized as an optical quality thin film.

In a multilayer architecture of alternating layers, each primary layer and each secondary layer may independently have a thickness ranging from approximately 10 nm to approximately 200 nm, e.g., 10, 20, 50, 100, 150, or 200 nm, including ranges between any of the foregoing values. A total multilayer stack thickness may range from approximately 1 micrometer to approximately 200 micrometers, e.g., 1, 2, 5, 10, 20, 50, 100, or 200 micrometers, including ranges between any of the foregoing values.

The areal dimensions (i.e., length and width) of a high surface quality optical thin film may independently range from approximately 1 cm to approximately 50 cm or more, e.g., 1, 2, 5, 10, 20, 30, 40, or 50 cm, including ranges between any of the foregoing values. Example thin films may have areal dimensions of approximately 5 cm×5 cm, 10 cm×10 cm, 20 cm×20 cm, 50 cm×50 cm, 5 cm×10 cm, 10 cm×20 cm, 10 cm×50 cm, etc.

A discontinuous spacer layer (i.e., stand-off layer) may be disposed over a major surface of an optical thin film, and sandwiched between adjacent optical thin films in a multilayer stack or roll. In particular embodiments, a spacer layer may be disposed directly over one or both major surfaces of an optical thin film. A discontinuous spacer layer may be a temporary layer that is implemented during manufacture or handling and removed prior to incorporating an optical thin film into an optical element.

In contrast to a continuous liner, a discontinuous spacer layer may be disposed over only portions of an optical thin film and accordingly define openings wherein the optical thin film may be exposed, i.e., prior to forming a further optical thin film over the spacer layer. The openings may be characterized by areal dimensions (e.g., length and width) independently ranging from approximately 1 cm to approximately 100 cm, e.g., 1, 2, 5, 10, 20, 50, or 100 cm, including ranges between any of the foregoing values. A discontinuous spacer layer may be configured as a web, mesh, or lattice that inhibits or prevents contact between adjacent optical thin films in a multilayer stack or between neighboring portions of an optical thin film in a rolled configuration.

The spacer layer may include one or more of a solid polymer, foam, or woven or non-woven fabric. In some embodiments, a composition of the spacer layer and a composition of the optical film may be independently selected from poly(methyl methacrylate), polycarbonate, polyethylene terephthalate, polyethylene naphthalate, cyclic olefin polymers, and cyclic olefin copolymers, as well as combinations thereof. In some embodiments, the spacer layer may be compositionally matched, and hence coefficient of thermal expansion (CTE)-matched or substantially matched, with the optical film.

In some embodiments, an optical thin film and a discontinuous spacer layer may be formed separately and co-integrated, e.g., prior to dicing and stacking or rolling of the optical thin film. A discontinuous spacer layer may be reversibly affixed to one or both major surfaces of an optical thin film. An example method of forming a discontinuous spacer layer over an optical thin film includes lamination, which may be a continuous method that is integrated with an optical film stretching process, for example. An adhesive layer may be used to affix a discontinuous spacer layer to an optical thin film. Suitable adhesives may include acrylates, silicones, urethanes, and the like. In certain embodiments, a 90° peel strength (i.e., bond strength) of the affixed spacer layer may be at least approximately 10 g/cm, e.g., 10 g/cm, 20 g/cm, 50 g/cm, or 100 g/cm, including ranges between any of the foregoing values.

In embodiments where the spacer layer is disposed over opposing major surfaces of an optical film, the peel strength of a spacer layer with respect to a first surface may be different than the peel strength of a spacer layer with respect to a second surface opposite to the first surface. For instance, a 90° peel strength of the spacer layer affixed to one major surface of an optical film may be at least approximately 10 g/cm, e.g., 10 g/cm, 20 g/cm, 50 g/cm, or 100 g/cm, including ranges between any of the foregoing values, whereas a 90° peel strength of the spacer layer affixed to the second major surface of the optical film may be less than approximately 10 g/cm, e.g., 10 g/cm, 5 g/cm, 2 g/cm, 1 g/cm, 500 mg/cm, 200 mg/cm, or 100 mg/cm, including ranges between any of the foregoing values.

A discontinuous spacer layer may include a plurality of raised rails that form a one-dimensional or a two-dimensional lattice that is configured to spatially separate major surfaces of opposing optical films. Raised rails may extend along a machine direction of an optical film, along a transverse direction of an optical film, or along any oblique angle, and may be characterized by a thickness of from approximately 10 micrometers to approximately 100 micrometers, e.g., 10, 20, 50, or 100 micrometers, including ranges between any of the foregoing values, and a width of from approximately 1 millimeter to approximately 10 millimeters, e.g., 1, 2, 5, or 10 millimeters, including ranges between any of the foregoing values. Such dimensions may be constant or may vary locally within a multilayer stack or roll. A raised rail may have any suitable cross-sectional shape, such as rectangular or trapezoidal.

In some configurations, a discontinuous spacer layer may be disposed between facing major optical film surfaces. In a stacked or rolled configuration, for instance, a bottom surface of a discontinuous spacer layer may be bonded to a major surface of an optical film and a top surface of the discontinuous spacer layer may abut an opposing major surface within the stack or roll such that the respective major surfaces are spatially offset. In some embodiments, one surface of a discontinuous spacer layer may be bonded to a major surface of an optical film whereas the opposing surface of the discontinuous spacer layer may be unbonded to an opposing major surface and accordingly slidably disposed with respect to the opposing major surface.

As will be appreciated, a discontinuous spacer layer includes openings wherein the optical film is exposed. Openings in the spacer layer may have any suitable shape, including square, rectangle, oval, circle, etc. The dimensions, including an aspect ratio of the openings, may be designed for specific applications. For example, the openings may be sized such that the high surface quality optical film exposed within each opening may be harvested and formed into an optical component such as an eyeglass lens.

According to further embodiments, a thin film package may include a stack of optical thin films and a discontinuous spacer layer located between opposing regions of neighboring optical thin films within the stack, where the spacer layer is configured to spatially separate the opposing regions of the optical thin films.

An example method may include forming a first optical thin film, forming a discontinuous spacer layer over a major surface of the first optical thin film, the discontinuous spacer layer including an opening, and forming a second optical thin film over the discontinuous spacer layer, where a portion of the major surface of the first optical thin film is spaced away from a portion of a major surface of the second optical thin film within the opening. The formation of the first and second optical thin films may include stretching and dicing or rolling operations. The discontinuous spacer layer may be reversibly or irreversibly bonded (e.g., laminated) to the first optical thin film and to the second optical thin film.

High surface quality optical films may be used as substrates for coatings such as hard coatings, metal coatings, dielectric coatings, and structured coatings such as moth's eye antireflective coatings to form liquid crystal retarders, cholesteric reflective polarizers, wire grid reflective polarizers, and replicated cast and cured polymers for microlens arrays and Fresnel lenses. Suitable dielectric materials may include silicon dioxide. Further example coatings may include liquid crystals, transparent conductive oxides (TCOs), and the like. A transparent conductive oxide coating may include indium tin oxide (ITO) or indium gallium zinc oxide (IGZO), for example.

As disclosed herein, a removable and discontinuous spacer layer may be disposed over a major surface of an optical thin film, and sandwiched between adjacent optical thin films in a multilayer stack or roll to protect the thin films from damage or debris, e.g., during transfer or storage. In particular embodiments, a spacer layer may be disposed directly between major surfaces of neighboring optical thin films. The discontinuous spacer layer may be characterized by a web, mesh, or lattice architecture, where in some embodiments a plurality of raised rails form a stand-off layer that physically separates adjacent optical thin films in a stack or roll while also defining openings wherein native surfaces of the optical thin film are exposed. The size and shape of the openings may be designed for specific applications. For instance, the exposed optical thin film within an opening may be harvested and formed into a lens for an optical system such as an augmented reality headset. The spacer layer and the optical thin film may be CTE-matched to mitigate the generation of thermally-induced stresses therebetween, e.g., during storage of the thin film/discontinuous spacer assembly.

Features from any of the embodiments described herein may be used in combination with one another in accordance with the general principles described herein. These and other embodiments, features, and advantages will be more fully understood upon reading the following detailed description in conjunction with the accompanying drawings and claims.

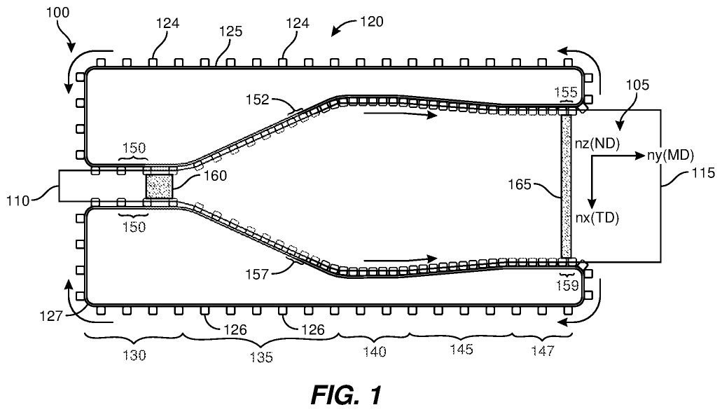

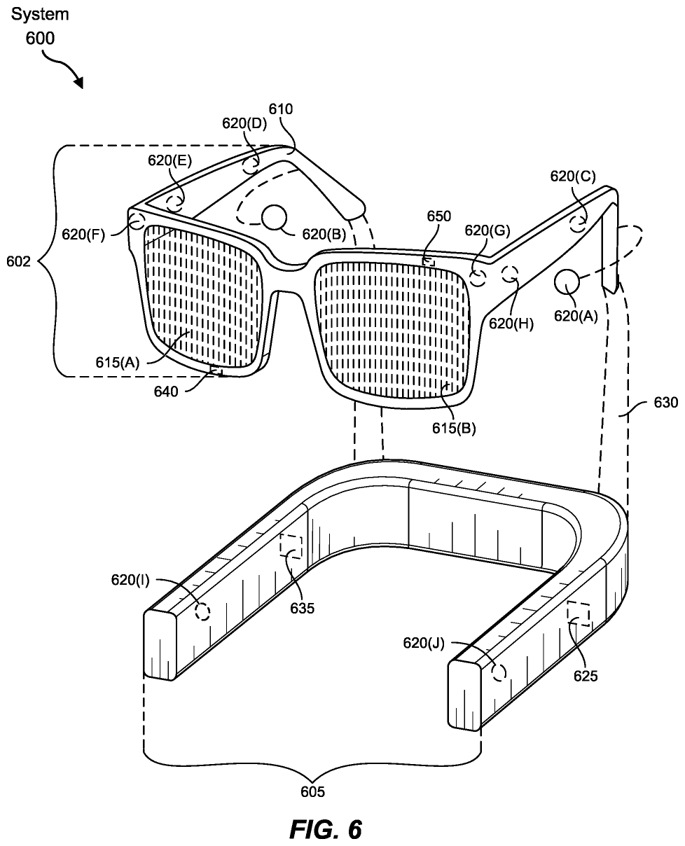

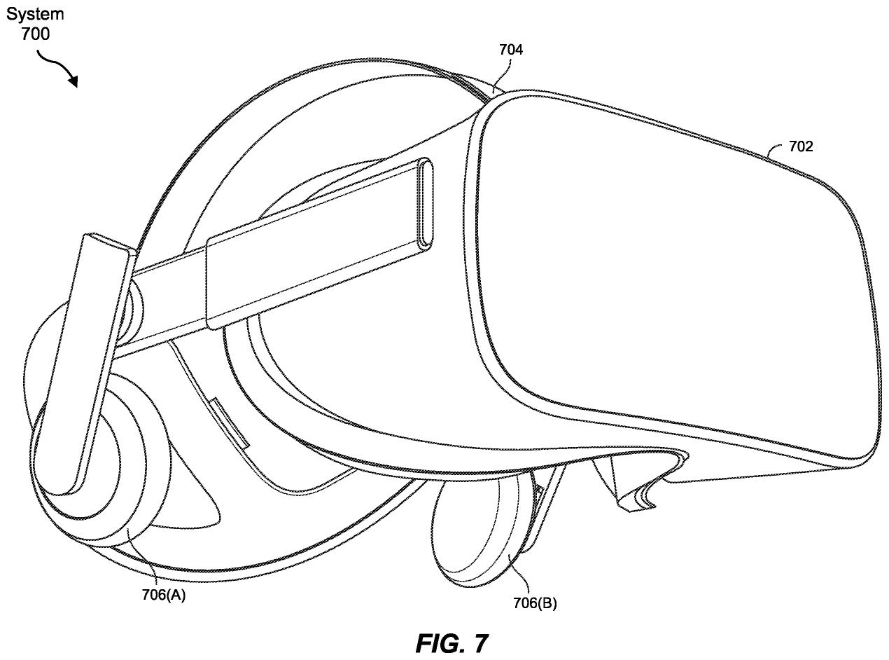

The following will provide, with reference to FIGS. 1-7, detailed descriptions of methods and systems for manufacturing high surface quality optical films. The discussion associated with FIGS. 1-5 relates to example thin film processing systems and methods. The discussion associated with FIGS. 6 and 7 relates to exemplary virtual reality and augmented reality devices that may include one or more high surface quality optical films as disclosed herein.

In some embodiments, the formation of a polymeric optical film may include stretching operations to orient crystals and/or molecules within the polymer material and form an anisotropic film. Accordingly, a thin film may be described with reference to three mutually orthogonal axes that are aligned with the machine direction (MD), the transverse direction (TD), and the normal direction (ND) of a thin film orientation system, and which may correspond respectively to the length, width, and thickness dimensions of the thin film. Throughout various embodiments and examples of the instant disclosure, the machine direction may correspond to the y-direction of a thin film, the transverse direction may correspond to the x-direction of the thin film, and the normal direction may correspond to the z-direction of the thin film. A “major surface” of a thin film may be an area defined by the machine and transverse directions (i.e., the film's length and width).

A single stage thin film orientation system for forming an optically anisotropic polymer thin film is shown schematically in FIG. 1. System 100 may include a thin film input zone 130 for receiving and pre-heating a thin film 105, a thin film output zone 147 for outputting an oriented portion 115 of the thin film 105, and a clip array 120 extending between the input zone 130 and the output zone 147 that is configured to grip and guide the thin film 105 through the system 100, i.e., from the input zone 130 to the output zone 147. Clip array 120 may include a plurality of movable first clips 124 that are slidably disposed on a first track 125 and a plurality of movable second clips 126 that are slidably disposed on a second track 127.

Thin film 105 may include a single polymer layer or multiple (e.g., alternating) layers of first and second polymers, such as a multilayer ABAB . . . structure. During operation, proximate to input zone 130, clips 124, 126 may be affixed to respective edge portions of polymer thin film 105, where adjacent clips located on a given track 125, 127 may be disposed at an inter-clip spacing 150. For simplicity, in the illustrated view, the inter-clip spacing 150 along the first track 125 within input zone 130 may be equivalent or substantially equivalent to the inter-clip spacing 150 along the second track 127 within input zone 130. As will be appreciated, in alternate embodiments, within input zone 130, the inter-clip spacing 150 along the first track 125 may be different than the inter-clip spacing 150 along the second track 127.

In addition to input zone 130 and output zone 147, system 100 may include one or more additional zones 135, 140, 145, etc., where each of: (i) the translation rate of the polymer thin film 105, (ii) the shape of first and second tracks 125, 127, (iii) the spacing between first and second tracks 125, 127, (iv) the inter-clip spacing 150, 152, 155, 157, 159, and (v) the local temperature of the polymer thin film 105, etc. may be independently controlled.

In an example process, as it is guided through system 100 by clips 124, 126, polymer thin film 105 may be heated to a selected temperature within each of zones 130, 135, 140, 145, 147. Fewer or a greater number of thermally controlled zones may be used. As illustrated, within zone 135, first and second tracks 125, 127 may diverge along a transverse direction such that polymer thin film 105 may be stretched in the transverse direction while being heated, for example, to a temperature greater than its glass transition temperature.

Referring still to FIG. 1, within zone 135 the spacing 152 between adjacent first clips 124 on first track 125 and the spacing 157 between adjacent second clips 126 on second track 127 may decrease relative to the inter-clip spacing 150 within input zone 130. In certain embodiments, the decrease in clip spacing 152, 157 from the initial spacing 150 may scale approximately as the square root of the transverse stretch ratio. The actual ratio may depend on the Poisson's ratio of the polymer thin film as well as the requirements for the stretched thin film, including flatness, thickness, etc.

In some embodiments, the temperature of the polymer thin film 105 may be decreased as the stretched polymer thin film 105 enters zone 140. Rapidly decreasing the temperature (i.e., thermal quenching) following the act of stretching within zone 135 may enhance the conformability of the polymer thin film 105. In some embodiments, the polymer thin film 105 may be thermally stabilized, where the temperature of the polymer thin film 105 may be controlled within each of the post-stretch zones 140, 145, 147. A temperature of the polymer thin film may be controlled by forced thermal convection or by radiation, for example, IR radiation, or a combination thereof.

Downstream of stretching zone 135, according to some embodiments, a transverse distance between first track 125 and second track 127 may remain constant or, as illustrated, initially decrease (e.g., within zone 140 and zone 145) prior to assuming a constant or substantially constant separation distance (e.g., within output zone 147). In a related vein, the inter-clip spacing downstream of stretching zone 135 may increase or decrease relative to inter-clip spacing 152 along first track 125 and inter-clip spacing 157 along second track 127. For example, inter-clip spacing 155 along first track 125 within output zone 147 may be less than inter-clip spacing 152 within stretching zone 135, and inter-clip spacing 159 along second track 127 within output zone 147 may be less than inter-clip spacing 157 within stretching zone 135. According to some embodiments, the spacing between the clips may be controlled by modifying the local velocity of the clips on a linear stepper motor line, or by using an attachment and variable clip-spacing mechanism connecting the clips to the corresponding track.

According to various embodiments, as a tensile stress is applied to the polymer thin film along the transverse direction, a dynamic inter-clip spacing within the stretching zone may allow the polymer film to relax along the machine direction. By providing such a dynamic stress state, crystals within the polymer thin film may assume a preferred orientation with respect to both the transverse direction and the machine direction such that the crystals exhibit an anisotropic orientation resulting in an optically anisotropic polymer thin film 115 where nₓ>n_{z}>n_{y}.

In some embodiments, thermal stabilization downstream of stretching zone 135 may include additional crystallization of the polymer thin film. By continuing to decrease the inter-clip spacing along the tracks downstream of stretching zone 135, e.g., within zone 140 and within zone 145, relaxation of the polymer thin film along the machine direction during additional crystal growth may allow a compressive stress to be imposed along the machine direction of the polymer thin film and an attendant realization of a preferred orientation, i.e., along the machine direction, of the newly-formed crystals.

The strain impact of the thin film orientation system 100 is shown schematically with reference to unit segments 160, 165, which respectively illustrate pre-stretch dimensions and corresponding post-stretch dimensions for a selected area of polymer thin film 105. In the illustrated embodiment, polymer thin film 105 has a pre-stretch width (e.g., along the transverse direction) and a pre-stretch length (e.g., along the machine direction). As will be appreciated, a post-stretch width may be greater than the pre-stretch width and a post-stretch length may be less than the pre-stretch length.

Various embodiments relate to systems for applying a tensile stress to a polymer thin film along a first direction while allowing the polymer thin film to relax along a direction substantially orthogonal to the first direction, i.e., a second direction, to induce a desired in-plane optical anisotropy.

Following stretching and crystal/molecule alignment, thin film 105 (e.g., oriented portion 115 of thin film 105) may be protected by applying a removable spacer layer before the film is diced and stacked, or formed into a roll, and then stored or transported for further processing. A discontinuous spacer layer may be interleaved between adjacent optical thin films in a multilayer stack or roll.

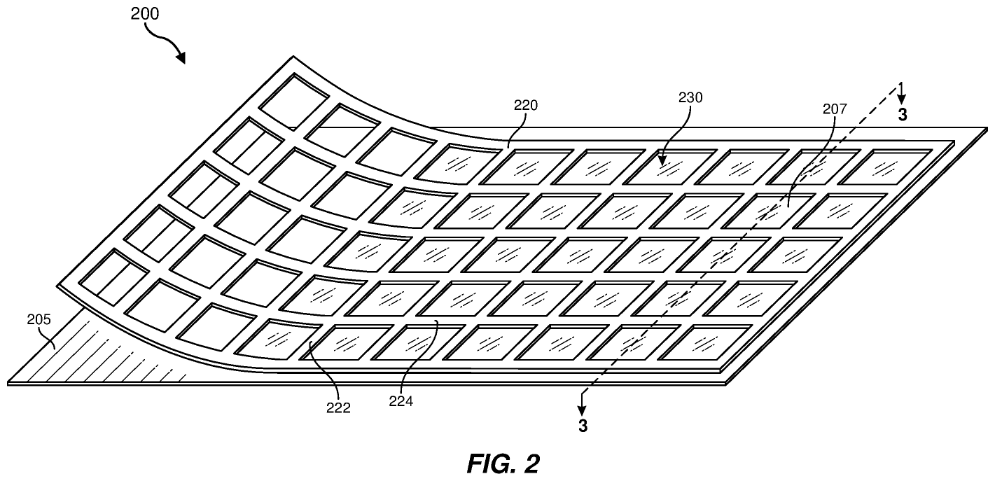

Referring to FIG. 2, illustrated at an intermediate stage of fabrication is an example structure for protecting a high surface quality optical film, where a thin film assembly 200 may include an optical thin film 205 (e.g., thin film 105) and a discontinuous spacer layer 220 disposed over a major surface of the optical thin film 205. The spacer layer 220 may include a plurality of raised rails that extend along mutually orthogonal directions, e.g., rails 222 extending along the transverse direction, and rails 224 extending along the machine direction of optical thin film 205. As depicted, the optical thin film 205 and the spacer layer 220 may be formed separately and laminated together using a suitable adhesive.

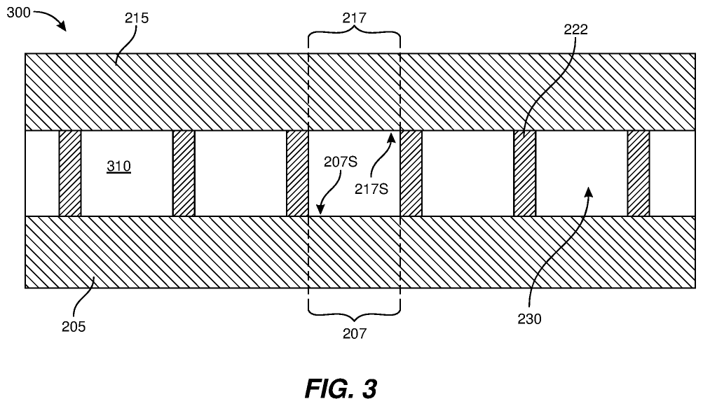

Discontinuous spacer layer 220 may directly overlie portions of the optical thin film 205 leaving openings 230 and corresponding regions 207 of the optical thin film 205 within the openings 230 that are configured to be protected by a subsequently laid-up and spaced away layer of a further optical thin film (not shown). A cross-sectional view along line 3-3 following the addition of a further optical thin film 215 is shown in FIG. 3. Referring to FIG. 3, protected surface 207S within region 207 of optical thin film 205 is spaced away from protected surface 217S located within region 217 of optical thin film 215. The thin film assembly 300 may include an air gap 310 within each opening 230 and between adjacent optical films 205, 215. In some cases, the openings 230 of adjacent sheets or layers on a roll may be aligned such that the openings 230 associated with successive layers overlap or substantially overlap.

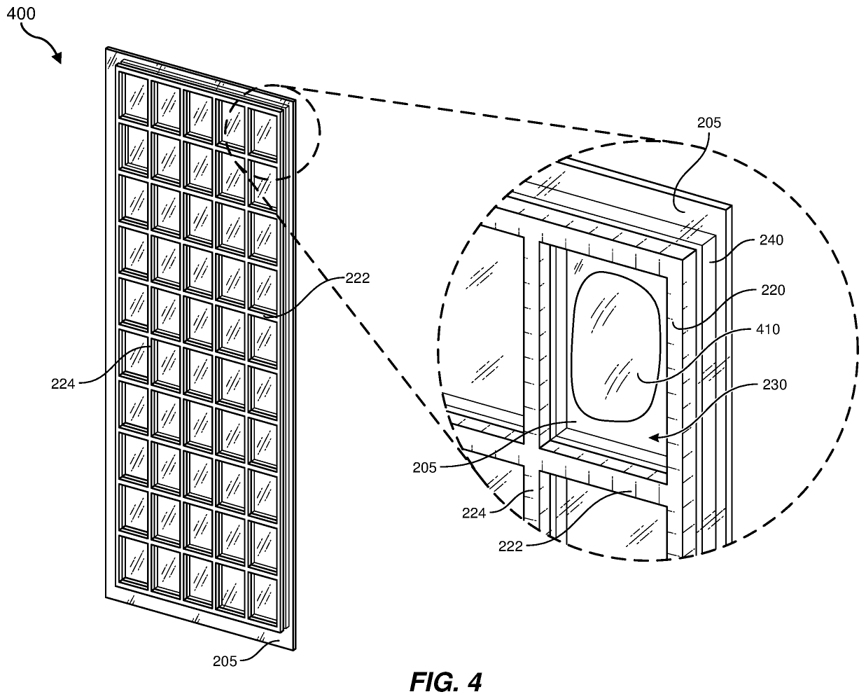

Referring to FIG. 4, illustrated is a further embodiment of a thin film assembly 400 where separate discontinuous spacer layers 220, 240 are respectively affixed to each major surface of an optical film 205. As shown, according to some embodiments, the spacer layers 220, 240 (e.g., rails 222 extending along the transverse direction and rails 224 extending along the machine direction) may be aligned to form a common opening 230 from which a protected optical film may be harvested and shaped into an optical component such as an eyeglass lens 410 having high surface quality.

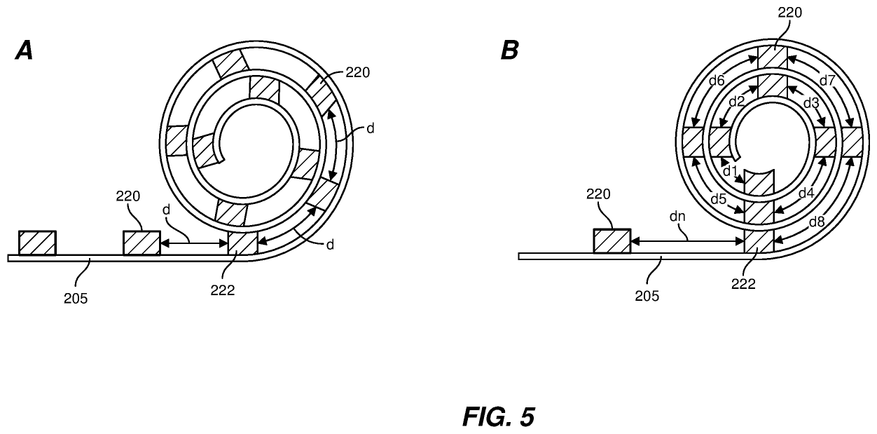

As an alternative to dicing and stacking individual optical films, a high surface quality optical film may be rolled for transport and storage. Turning to FIG. 5, shown are example rolled thin film assemblies that include an optical film 205 and an intervening discontinuous spacer layer 220 that is incorporated into the roll. In the examples of FIG. 5, an optical film and an overlying spacer layer may be rolled along the machine direction of the high surface quality optical film, although other rolling configurations are contemplated.

Referring to FIG. 5A, in some embodiments a distance (d) between raised rails 222 may be constant or substantially constant. In such case, the transverse rails may be disposed at regular intervals, but may be substantially misaligned with each other within the roll. In another embodiment, and with reference to FIG. 5B, a distance (d₁, d₂, . . . , dₙ) between raised rails 222 may be variable. In such a case, the variable and differential distance between transverse rails may be selected such that the rails and hence the associated openings are mutually aligned within the roll.

### Example Embodiments

Example 1: A thin film assembly includes an optical thin film and a discontinuous spacer layer disposed over a major surface of the optical thin film.

Example 2: The thin film assembly of Example 1, where a 90° peel strength of the spacer layer is at least approximately 10 g/cm.

Example 3: The thin film assembly of any of Examples 1 and 2, where an opening in the spacer layer has an areal dimension of from approximately 1 cm to approximately 100 cm.

Example 4: The thin film assembly of Example 3, where the optical thin film is exposed within the opening.

Example 5: The thin film assembly of any of Examples 1-4, where the spacer layer includes a plurality of raised rails.

Example 6: The thin film assembly of Example 5, where the raised rails have a thickness of from approximately 10 micrometers to approximately 100 micrometers and a width of from approximately 1 millimeter to approximately 10 millimeters.

Example 7: The thin film assembly of any of Examples 5 and 6, where the raised rails form a one-dimensional array.

Example 8: The thin film assembly of any of Examples 5-7, where the raised rails extend in a machine direction.

Example 9: The thin film assembly of any of Examples 5-8, where the raised rails extend in a transverse direction.

Example 10: The thin film assembly of any of Examples 5-9, where the raised rails form a two-dimensional array.

Example 11: The thin film assembly of any of Examples 1-10, where the optical thin film includes glass.

Example 12: The thin film assembly of any of Examples 1-11, where a thickness of the optical thin film is less than approximately 100 micrometers.

Example 13: The thin film assembly of any of Examples 1-12, where the optical thin film includes a polymer.

Example 14: The thin film assembly of Example 13, where the polymer is optically anisotropic.

Example 15: The thin film assembly of any of Examples 13 and 14, where the polymer is selected from poly(methyl methacrylate), polycarbonate, polyethylene terephthalate, polyethylene naphthalate, a cyclic olefin polymer, and a cyclic olefin copolymer.

Example 16: The thin film assembly of any of Examples 13-15, further including a coating disposed over the optical thin film, where the coating is selected from a dielectric coating, a liquid crystal coating, and a transparent conductive oxide coating.

Example 17: The thin film assembly of any of Examples 1-16, where the optical thin film constitutes a multilayer reflective polarizer.

Example 18: The thin film assembly of any of Examples 1-16, where the optical thin film constitutes a wire grid array reflective polarizer.

Example 19: A thin film package includes a stack of plural optical thin films and a discontinuous spacer layer located between opposing regions of neighboring optical thin films within the stack, where the spacer layer is configured to spatially separate the opposing regions.

Example 20: A method includes forming a first optical thin film, forming a discontinuous spacer layer over a major surface of the first optical thin film, the discontinuous spacer layer having an opening, and forming a second optical thin film over the discontinuous spacer layer, where a portion of the major surface of the first optical thin film is spaced away from a portion of a major surface of the second optical thin film within the opening.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 600 in FIG. 6) or that visually immerses a user in an artificial reality (e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

Augmented-reality system 600 may also include a microphone array with a plurality of acoustic transducers 620(A)-620(J), referred to collectively as acoustic transducers 620. Acoustic transducers 620 may be transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(F) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a Bluetooth connection). In still other embodiments, acoustic transducers 620(A) and 620(B) may not be used at all in conjunction with augmented-reality system 600.

Acoustic transducers 620 on frame 610 may be positioned along the length of the temples, across the bridge, above or below display devices 615(A) and 615(B), or some combination thereof. Acoustic transducers 620 may be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 7, output audio transducers 706(A) and 706(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 6, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an optical film that comprises or includes polycarbonate include embodiments where an optical film consists essentially of polycarbonate and embodiments where an optical film consists of polycarbonate.

1. A thin film assembly comprising:
an optical thin film; and
a discontinuous spacer layer disposed over a major surface of the optical thin film.

2. The thin film assembly of claim 1, wherein a 90° peel strength of the spacer layer is at least approximately 10 g/cm.

3. The thin film assembly of claim 1, wherein an opening in the spacer layer has an areal dimension of from approximately 1 cm to approximately 100 cm.

4. The thin film assembly of claim 3, wherein the optical thin film is exposed within the opening.

5. The thin film assembly of claim 1, wherein the spacer layer comprises a plurality of raised rails.

6. The thin film assembly of claim 5, wherein the raised rails have a thickness of from approximately 10 micrometers to approximately 100 micrometers and a width of from approximately 1 millimeter to approximately 10 millimeters.

7. The thin film assembly of claim 5, wherein the raised rails form a one-dimensional array.

8. The thin film assembly of claim 5, wherein the raised rails extend in a machine direction.

9. The thin film assembly of claim 5, wherein the raised rails extend in a transverse direction.

10. The thin film assembly of claim 5, wherein the raised rails form a two-dimensional array.

11. The thin film assembly of claim 1, wherein the optical thin film comprises glass.

12. The thin film assembly of claim 11, wherein a thickness of the optical thin film is less than approximately 100 micrometers.

13. The thin film assembly of claim 1, wherein the optical thin film comprises a polymer.

14. The thin film assembly of claim 13, wherein the polymer is optically anisotropic.

15. The thin film assembly of claim 13, wherein the polymer is selected from the group consisting of poly(methyl methacrylate), polycarbonate, polyethylene terephthalate, polyethylene naphthalate, a cyclic olefin polymer, and a cyclic olefin copolymer.

16. The thin film assembly of claim 13, further comprising a coating disposed over the optical thin film, wherein the coating is selected from the group consisting of a dielectric coating, a liquid crystal coating, and a transparent conductive oxide coating.

17. The thin film assembly of claim 13, wherein the optical thin film comprises a multilayer reflective polarizer.

18. The thin film assembly of claim 13, wherein the optical thin film comprises a wire grid array reflective polarizer.

19. A thin film package comprising:
a stack comprising plural optical thin films; and
a discontinuous spacer layer located between opposing regions of neighboring optical thin films within the stack, wherein the spacer layer is configured to spatially separate the opposing regions.

20. A method comprising:
forming a first optical thin film;
forming a discontinuous spacer layer over a major surface of the first optical thin film, the discontinuous spacer layer comprising an opening; and
forming a second optical thin film over the discontinuous spacer layer, wherein a portion of the major surface of the first optical thin film is spaced away from a portion of a major surface of the second optical thin film within the opening.
